(19) United States
(12) Patent Application Publication
(10) Pub. No.: US 2026/0118714 A1
(43) Pub. Date: Apr. 30, 2026

(54) BACKLIGHT MODULE AND DISPLAY DEVICE

(71) Applicants: Huizhou China Star Optoelectronics Display Co., Ltd., Huizhou, Guangdong (CN); TCL China Star Optoelectronics Technology Co., Ltd., Shenzhen, Guangdong (CN)

(72) Inventors: Yunfei DAI, Huizhou, Guangdong (CN); Jing LIU, Huizhou, Guangdong (CN); Hongzhao DENG, Huizhou, Guangdong (CN)

(73) Assignees: Huizhou China Star Optoelectronics Display Co., Ltd., Huizhou, Guangdong (CN); TCL China Star Optoelectronics Technology Co., Ltd., Shenzhen, Guangdong (CN)

(21) Appl. No.: 18/270,263

(22) PCT Filed: Apr. 21, 2023
(86) PCT No.: PCT/CN2023/089837

§ 371 Date: Jun. 29, 2023

(30) Foreign Application Priority Data
Mar. 31, 2023 (CN) 202310348486.7

(51) Int. Cl. G02F 1/13357

(52) U.S. Cl. CPC G02F 1/133603

(57) ABSTRACT

The present disclosure provides a backlight module and a display device, wherein a first conductive layer is disposed on a substrate and includes signal traces and a first ground line unit; a second conductive layer is disposed on a side of the first conductive layer close to or away from the substrate. The second conductive layer includes a second ground line unit. The light-emitting member is electrically connected with the signal traces and the first ground line unit, and the first ground line unit is connected with the second ground line unit.

The present disclosure claims priority to Chinese Patent Application No. 202310348486.7, filed on Mar. 31, 2023, and entitled “backlight module and display device”, the disclosure of which is incorporated herein by reference in its entirety.

### TECHNICAL FIELD

The present disclosure relates to the technical field of display, and in particular, to a backlight module and a display device.

### BACKGROUND OF INVENTION

A mini light-emitting diode (Mini LED) backlight module includes thousands of independent micro-sized LED light sources, which can be more advantages in contrast ratio, brightness, and power consumption. Mini LED has a contrast ratio that is quite close to that of organic light-emitting diode display devices., Through super multi-zone technology, Mini LED can finely control the backlight source, realizes HDR ultra-wide dynamic range display, and greatly improves image quality. Moreover, the cost and power consumption of a Mini LED are lower than those of an organic light-emitting diode display device, while, Mini LED has excellent image quality performance, and is increasingly recognized by consumers.

In a Mini LED backlight module, signals required by a LED backlight source are transmitted by traces extending into the plane, thereby realizing the multi-zone fine control of the Mini LED backlight module. However, in-plane traces are limited by space, and have higher resistance when wiring in a limitedcom space, which may cause a large voltage drop, and may cause the Mini LED backlight module to generate heat, thus increasing power consumption and affecting stability.

### SUMMARY OF INVENTION

Examples of the present disclosure provide a backlight module and a display device, which can reduce a width of a first ground line unit, increase width of signal traces, improve the phenomenon of voltage drop and heat generation, reduce power consumption, and improve stability of a backlight module.

Examples of the present disclosure provide a backlight module, which comprises:
a substrate;
a first conductive layer disposed on the substrate and comprising a signal trace and a first ground line unit;
a second conductive layer disposed on a side of the first conductive layer close to or away from the substrate and comprising a second ground line unit; and
a light-emitting member electrically connected with the signal trace and the first ground line unit;
wherein the first ground line unit is connected with the second ground line unit.

In an example of the present disclosure, the backlight module comprises a light-emitting area, a peripheral area adjacent to the light-emitting area, and a driving assembly disposed in the peripheral area; the light-emitting member is disposed in the light-emitting area; the first ground line unit comprises a first trace disposed in the peripheral area and a second trace disposed in the light-emitting area, the first trace is connected between the second trace and the driving assembly, and the second trace is connected between the light-emitting member and the first trace; and
wherein the first trace and/or the second trace is connected with the second ground line unit.

In an example of the present disclosure, the backlight module further comprises an insulating layer disposed between the second conductive layer and the first conductive layer, at least one first via located in the peripheral area is disposed in the insulating layer, and the first trace is connected with the second ground line unit through the at least one first via.

In an example of the present disclosure, the second ground line unit comprises a first sub-section disposed in the peripheral area, an orthographic projection of the first trace on the substrate is located within an orthographic projection of the first sub-section on the substrate, and the at least one first via is located between the first sub-section and the first trace.

In an example of the present disclosure, the backlight module further comprises an insulating layer disposed between the second conductive layer and the first conductive layer, at least one second via located in the light-emitting area is disposed in the insulating layer, and the second trace is connected with the second ground line unit through the at least one second via.

In an example of the present disclosure, the second ground line unit comprises a second sub-section disposed in the light-emitting area, an orthographic projection of the second trace on the substrate is located within an orthographic projection of the second sub-section on the substrate, and the at least one second via is located between the second sub-section and the second trace.

In an example of the present disclosure, the second ground line unit corresponds to the light-emitting area and the peripheral area and covers one side of the first conductive layer, and both of an orthographic projection of the first ground line unit on the substrate and an orthographic projection of the signal trace on the substrate are located within an orthographic projection of the second ground line unit on the substrate.

In an example of the present disclosure, the second conductive layer is disposed between the substrate and the first conductive layer, and an orthographic projection of the light-emitting member on the substrate is located within an orthographic projection of the second ground line unit on the substrate.

In an example of the present disclosure, the second conductive layer is provided on the side of the first conductive layer away from the substrate, and an opening corresponding to the light-emitting member is disposed in the second ground line unit.

In an example of the present disclosure, a width of the signal trace is greater than or equal to 30 microns.

In an example of the present disclosure, the backlight module comprises a light-emitting circuit unit disposed in the light-emitting area, and the light-emitting member is connected with the light-emitting circuit unit, and the signal trace comprises a light-emitting signal line and a power line connected with the light-emitting circuit unit.

According to the above object of the present disclosure, examples of the present disclosure further provides a display device including a backlight module and a display panel, wherein the display panel is disposed at a light emitting side of the backlight module;
the backlight module comprises:
a substrate;
a first conductive layer disposed on the substrate and comprising a signal trace and a first ground line unit;
a second conductive layer disposed on a side of the first conductive layer close to or away from the substrate and comprising a second ground line unit; and
a light-emitting member electrically connected with the signal trace and the first ground line unit;
wherein the first ground line unit is connected with the second ground line unit.

In an example of the present disclosure, the backlight module comprises a light-emitting area, a peripheral area adjacent to the light-emitting area, and a driving assembly disposed in the peripheral area; the light-emitting member is disposed in the light-emitting area; the first ground line unit comprises a first trace disposed in the peripheral area and a second trace disposed in the light-emitting area, the first trace is connected between the second trace and the driving assembly, and the second trace is connected between the light-emitting member and the first trace; and
wherein the first trace and/or the second trace is connected with the second ground line unit.

In an example of the present disclosure, the backlight module further comprises an insulating layer disposed between the second conductive layer and the first conductive layer, at least one first via located in the peripheral area is disposed in the insulating layer, and the first trace is connected with the second ground line unit through the at least one first via.

In an example of the present disclosure, the second ground line unit comprises a first sub-section disposed in the peripheral area, an orthographic projection of the first trace on the substrate is located within an orthographic projection of the first sub-section on the substrate, and the at least one first via is located between the first sub-section and the first trace.

In an example of the present disclosure, the backlight module further comprises an insulating layer disposed between the second conductive layer and the first conductive layer, at least one second via located in the light-emitting area is disposed in the insulating layer, and the second trace is connected with the second ground line unit through the at least one second via.

In an example of the present disclosure, the second ground line unit comprises a second sub-section disposed in the light-emitting area, an orthographic projection of the second trace on the substrate is located within an orthographic projection of the second sub-section on the substrate, and the at least one second via is located between the second sub-section and the second trace.

In an example of the present disclosure, the second ground line unit corresponds to the light-emitting area and the peripheral area and covers one side of the first conductive layer, and both of an orthographic projection of the first ground line unit on the substrate and an orthographic projection of the signal trace on the substrate are located within an orthographic projection. of the second ground line unit on the substrate

In an example of the present disclosure, the second conductive layer is disposed between the substrate and the first conductive layer, and an orthographic projection of the light-emitting member on the substrate is located within an orthographic projection of the second ground line unit on the substrate.

In an example of the present disclosure, the second conductive layer is provided on the side of the first conductive layer away from the substrate, and an opening corresponding to the light-emitting member is disposed in the second ground line unit.

### ADVANTAGEOUS EFFECTS

According to the present disclosure, a second conductive layer disposed in a different layer from the first conductive layer is added, and the second conductive layer includes a second ground line unit connected with the first ground line unit in the first conductive layer. Compared with the related arts, in which signal traces and ground lines need to be formed in the same metal layer, the ground lines in the present disclosure are divided into a second ground line unit and a first ground line unit disposed in different layers, so that the width of the first ground line unit can be reduced to provide more space for the first conductive layer. In this case, the width of the signal traces can be increased according to actual requirements, the resistance of the signal traces can be reduced, the phenomenon of voltage drop and heating generation can be improved, the power consumption of the backlight module can be reduced, and the stability of the backlight module can be improved.

### DESCRIPTION OF THE DRAWINGS

The technical solutions and other beneficial effects of the present disclosure will be apparent from the detailed description of specific embodiments of the present disclosure with reference to the accompanying drawings.

FIG. 1 is a schematic plan view of one kind of wire-layout in a backlight module according to the related arts.

FIG. 2 is a schematic across-sectional structural diagram of one kind of wiring layout in a backlight module according to the related arts.

FIG. 3 is schematic structural diagram of a backlight module located in a light-emitting area according to an example of the present disclosure.

FIG. 4 is a schematic plan view of one kind of wire-layout in a backlight module located in a light-emitting area according to an example of the present disclosure.

FIG. 5 is a schematic structural diagram of a backlight module located in a peripheral area according to an example of the present disclosure.

FIG. 6 is a schematic plan view of one kind of wire-layout in a backlight module located in a peripheral area according to an example of the present disclosure.

FIG. 7 is another schematic diagram of a backlight module according to an example of the present disclosure.

FIG. 8 is a schematic plan view of a backlight module located in a light-emitting area according to an example of the present disclosure.

### EMBODIMENTS OF INVENTION

Hereinafter, technical solutions in embodiments of the present disclosure will be clearly and completely described with reference to the accompanying drawings in embodiments of the present disclosure. Apparently, the described embodiments comprise but are not limited to the embodiments of the present disclosure. Other embodiments that can be obtained by a person with ordinary skill in the art on the basis of the embodiments in the present disclosure without creative labor belong to the protection scope of the present disclosure.

The following description provides different embodiments or examples for implementing different structures of the present disclosure. In order to simplify the present disclosure, components and arrangements of specific examples are described below. It is clear that they are merely examples and are not intended to limit the present disclosure. In addition, reference numerals and/or reference letters are repeated in different examples. Such repetition is for the purpose of simplification and clarity, and it does not indicate the relationship between the various embodiments and/or settings discussed. Furthermore, the present disclosure provides examples of various specific processes and materials, but people of ordinary skill in the art may be aware of the application of other processes and/or the use of other materials.

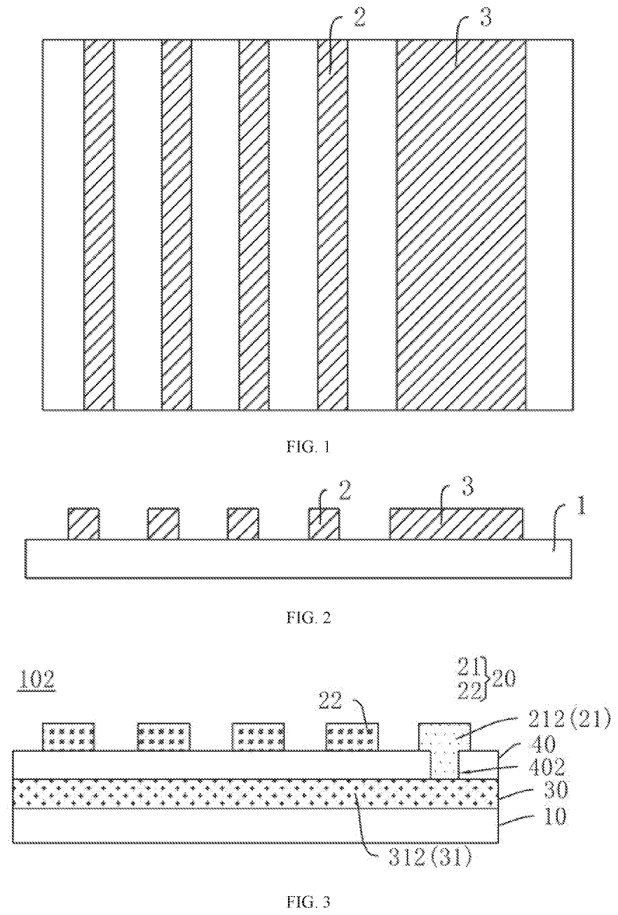

Referring to FIGS. 1 and 2, in the related arts, a Mini LED backlight module includes a substrate 1, signal traces 2 disposed on the substrate 1, an LED lamp, and a ground line 3. The signal traces 2 may include a power line or other signal control lines for transmitting signals, and the ground line 3 may be electrically connected with a negative electrode of the LED lamp. Since the ground wire 3 needs to be maintained at a low potential, it is necessary to make the ground line 3 have a large current release capability. Generally, the width of the ground line 3 is relatively large, which will occupy space for wiring on the substrate 1, making the width of other signal traces 2 narrower, resulting in higher resistance of the signal traces 2, which is prone to cause phenomenon of heat generation and voltage drop, thereby causing the backlight module to emit light unevenly and affecting the stability of the backlight module.

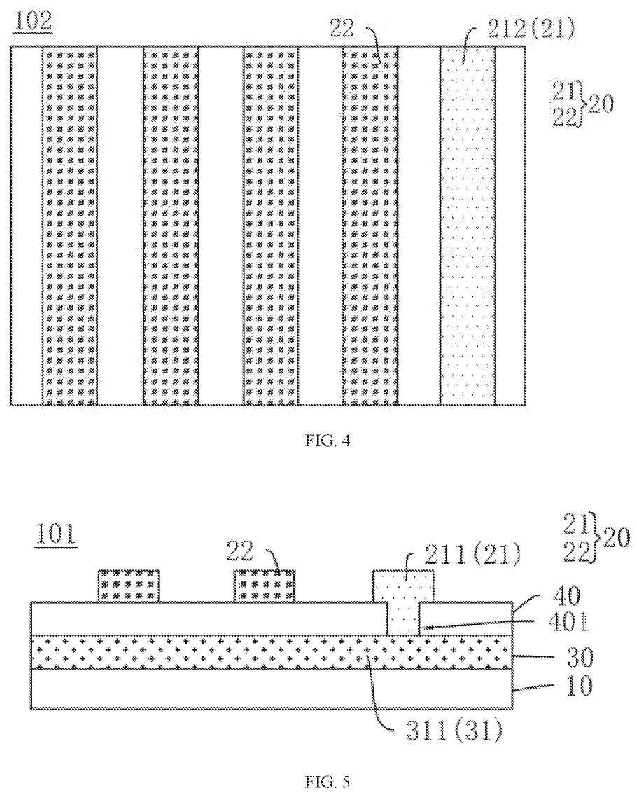

Referring to FIGS. 3 and 4, examples of the present disclosure provide a backlight module including a substrate 10, a first conductive layer 20, a second conductive layer 30, and a light-emitting member (not shown).

The first conductive layer 20 is disposed above the substrate 10 and includes signal traces 22 and a first ground line unit 21. The second conductive layer 30 is disposed on one side of the first conductive layer 20 close to or away from the substrate 10, and the second conductive layer 30 includes a second ground line unit 31. The light-emitting member is electrically connected with the signal traces 22 and the first ground line unit 21.

Further, the first ground line unit 21 is connected with the second ground line unit 31.

In the process of implementation and application, the second conductive layer 30 disposed in a different layer from the first conductive layer 20 is added, and the second conductive layer 30 includes a second ground line unit 31 connected with the first ground line unit 21 in the first conductive layer 20. Compared with the related arts shown in FIG. 1 and FIG. 2, in which signal traces 3 and ground lines 3 need to be formed in the same metal layer, the ground lines in examples of the present disclosure are divided into a second ground line unit 31 and a first ground line unit 21 disposed in different layers, so that the width of the first ground line unit 21 can be reduced to provide more space for the first conductive layer 20. In this case, the width of the signal traces 22 can be increased according to actual requirements, the resistance of the signal traces 22 can be reduced, the phenomenon of voltage drop and heating generation can be improved, the power consumption of the backlight module can be reduced, and the stability of the backlight module can be improved.

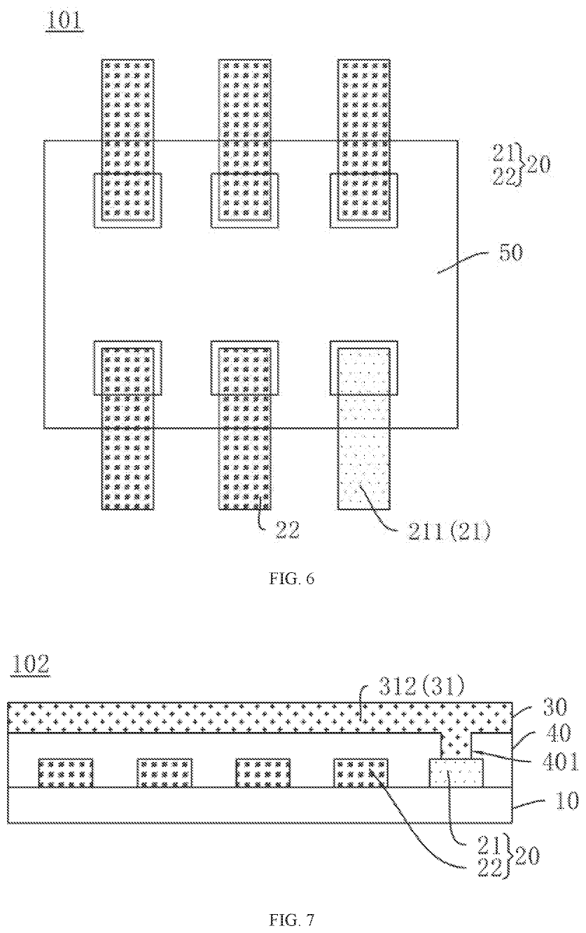

In examples of the present disclosure, referring to FIG. 3, FIG. 4, FIG. 5 and FIG. 6, the backlight module includes a light-emitting area 102 in which wirings and a light-emitting member are formed, and a peripheral area 101 adjacent to the light-emitting area 102 in which wire-layout and other components are formed. FIGS. 3 and 4 are schematic diagrams showing wire-layout in the light-emitting area 102, and FIGS. 5 and 6 are schematic diagrams showing wire-layout in the peripheral area 101.

Specifically, the backlight module includes a substrate 10, a wiring layer disposed above the substrate 10, and a light-emitting member connected to traces in the wire-layout layer. It should be noted that examples of the present disclosure are directed to issues in the related arts that the backlight module is prone to heat generation and voltage drop due to the narrow width and high resistance of the signal traces caused by narrow wire-layout space, and further improves the structure of the wire-layout layer to eliminate the adverse phenomenon in the backlight module.

Alternatively, the substrate 10 may include a substrate formed of a glass material or a substrate formed of a resin material.

Further, the wire-layout layer includes a first conductive layer 20 disposed above the substrate 10, a second conductive layer 30 disposed on one side of the first conductive layer 20 close to the substrate 10, and an insulating layer 40 disposed between the first conductive layer 20 and the second conductive layer 30.

The first conductive layer 20 includes a first ground line unit 21 and signal traces 22, and the second conductive layer 30 includes a second ground line unit 31. The first ground line unit 21 is connected with the second ground line unit 31 to replace ground line having a large width in the related arts. In the implementation of the present disclosure, the second conductive layer 30 is added to form the second ground line unit 31, and the ground line are divided into two parts, thereby ensuring the current release capability of the ground lines while reducing the width required by the first ground line unit 21 in the first conductive layer 20 to save the wire-layout space in the first conductive layer 20. Further, the signal traces 22 can be set wider as needed and the resistance thereof can be reduced.

In an example, the backlight module includes a light-emitting circuit unit disposed in the light-emitting area 102, and the light-emitting member is connected with the light-emitting circuit unit. For example, the light-emitting circuit unit may include transistors for controlling signal transmission, capacitors for improving signal stability, and the like, and the signal traces 22 may include power lines connected with the light-emitting circuit unit, and light-emitting signal lines. Further, the first ground line unit 21 includes a plurality of first traces 211 disposed in the peripheral area 101 and a plurality of second traces 212 disposed in the light-emitting area 102. In examples of the present disclosure, since the second ground line unit 31 is added, the width of the second traces 212 can be reduced compared with the related arts, so as to save wire-layout space and increase the width of the signal traces 22, that is, to increase the width of the power lines and the light-emitting signal lines, so as to reduce the resistance of the power lines and the light-emitting signal lines, thereby improving transmission efficiency of power signals in the power lines, reducing the loss and reducing power consumption of the backlight module. Meanwhile, the light-emitting signal lines can be electrically connected to an positive electrode of the light-emitting member, and the second traces 212 are electrically connected with a negative electrode of the light-emitting member. With the increase of width of the light-emitting signal lines, the phenomenon of voltage drop in the light-emitting signal lines can be improved, the light-emitting uniformity of the backlight module can be improved, and the stability of the backlight module can be improved.

Alternatively, the width of the signal traces 22 may be greater than or equal to 30 microns and less than or equal to 1,000 microns. The material of each of the first conductive layer 20 and the material of the second conductive layer 30 independently include at least one of Au, Ag, Cu and Al.

In addition, the backlight module further includes a driving assembly 50 disposed in the peripheral area 101. The second traces 212 are connected between the light emitting member and the first traces 211, and the first traces 211 are connected between the second traces 212 and the driving assembly 50. One end of each of the signal traces 22 is connected with the light-emitting circuit unit, and the other end extends to the peripheral area 101 to be connected with the driving assembly 50.

In examples of the present disclosure, at least one via is disposed in the insulating layer 40, so that the first ground line unit 21 can be connected with the second ground line unit 31 through the via hole.

In one embodiment, as shown in FIGS. 5 and 6, at least one first via 401 located in the peripheral area 101 is disposed in the insulating layer 40, and the first traces 211 are connected with the second ground line unit 31 through the first via 401. The first via 401 may be located in an area corresponding to the driving assembly 50 or any area in the peripheral region 101 where the first traces 211 are located.

The second ground line unit 31 includes a first sub-portion 311 disposed in the peripheral area 101, and the first traces 211 are connected with the first sub-portion 311 through the first via 401. An orthographic projection of the first trace 311 on the substrate 10 is located within an orthographic projection of the first sub-section 311 on the substrate 10, and the first via 401 is located between the first trace 211 and the first sub-portion 311.

In another example, as shown in FIGS. 3 and 4, at least one second via 402 located in the light-emitting area 102 is disposed in the insulating layer 40, and the second trace 212 is connected with the second ground line unit 31 through the second via 402. The second via 402 may be any area in the light-emitting area 102 where the second traces 212 are located.

The second ground line unit 31 includes a second sub-portion 312 disposed in the light-emitting area 102, and the second trace 212 is connected with the second sub-portion 312 through the second via 402. An orthographic projection of the second traces 212 on the substrate 10 is located within an orthographic projection of the second sub-section 312 on the substrate 10, and the second via 402 is located between the second traces 212 and the second sub-portion 312.

In another example, combining with the above two examples, that is, a first via 401 located in the peripheral area 101 and a second via 402 located in the light emitting area 102 are simultaneously disposed in the insulating layer 40, wherein the first traces 211 are connected with the first sub-portion 311 through the first via 401, and the second traces 212 are connected with the second sub-portion 312 through the second via 402. Meanwhile, the first sub-portion 311 and the second sub-portion 312 are connected to realize connection between the first ground line unit 21 and the second ground line unit 31.

It should be noted that, in the above three examples, the number and position of the first via 401 and/or the second via 402 are not limited; and the more the number of the first via 401 and/or the second via 402, the smaller the contact resistance between the first ground line unit 21 and the second ground line unit 31, making the ability of the first ground wire unit 21 and the second ground wire unit 31 to release current stronger. Therefore, the line width of the first line 211 and the second line 212 in the first ground wire unit 21 can be smaller, and correspondingly, the line width of the signal line 22 can be larger.

Based on the above, in examples of the present disclosure, the second ground line unit 31 corresponds to the light-emitting area 102 and the peripheral area 101 and covers the entire surface between the substrate 10 and the first conductive layer 20. The second ground line unit 31 corresponds to the light-emitting area 102 and the peripheral area 101 indicates that the coverage area of the second ground line unit 31 can overlap with the light-emitting area 102 and the peripheral area 101, so that the second ground line unit 31 has a larger area. The orthographic projection of the light-emitting member on the substrate 10, the orthographic projection of the first ground line unit 21 on the substrate 10, and the orthographic projection of the signal traces 22 on the substrate 10 can all be located in the orthographic projection of the second ground line unit 31 on the substrate 10.

Alternatively, the shape of the second ground line unit 31 may include a square, a rhombus, a rectangle or a circle.

It should be noted that, because the second ground line unit 31 is additionally provided in examples of the present disclosure, and the current release capability of the first ground line unit 21 and the second ground line unit 31 is much higher than that of the ground line in the related arts, the first ground line unit 21 and the second ground line unit 31 in examples of the present disclosure may also be reused as anti-static devices to protect the light-emitting members or other components in the backlight module from static electricity.

In addition, in the implementation of the present disclosure, the layouts of the signal traces 22 and the first ground line unit 21 shown in FIGS. 4 and 6 are merely examples, it is not limited to them, and it can be disposed in an array, or in a discrete arrangement, or the like. The method of forming the first conductive layer 20 and the second conductive layer 30 on the substrate 10 can be independently selected from any one of electroplating, screen printing and evaporation plating.

Furthermore, the backlight module provided in the examples of the present disclosure can be actively driven or passively driven, and the light-emitting member may be an LED lamp. The backlight module provided in examples of the present disclosure may be applied to Mini LED backlight.

Based on the above, the second conductive layer 30 disposed in a different layer from the first conductive layer 20 is added, and the second conductive layer 30 includes a second ground line unit 31 connected with the first ground line unit 21 in the first conductive layer 20. Compared with the related arts shown in FIG. 1 and FIG. 2, in which signal traces 3 and ground line 3 need to be formed in the same metal layer, the ground lines in examples of the present disclosure are divided into a second ground line unit 31 and a first ground line unit 21 disposed in different layers, so that the width of the first ground line unit 21 can be reduced to provide more space for the first conductive layer 20. In this case, the width of the signal traces 22 can be increased according to actual requirements, the resistance of the signal traces 22 can be reduced, the phenomenon of voltage drop and heating generation can be improved, the power consumption of the backlight module can be reduced, and the stability of the backlight module can be improved. In addition, because the first ground line unit 21 and the second ground line unit 31 provided in examples of the present disclosure have strong current release capabilities, the first ground line unit 21 and the second ground line unit 31 can also be used as an anti-static devices, which not only protect the light emitting members or other components in the backlight module from static electricity, but also save the cost of additionally installing anti-static devices in the backlight module.

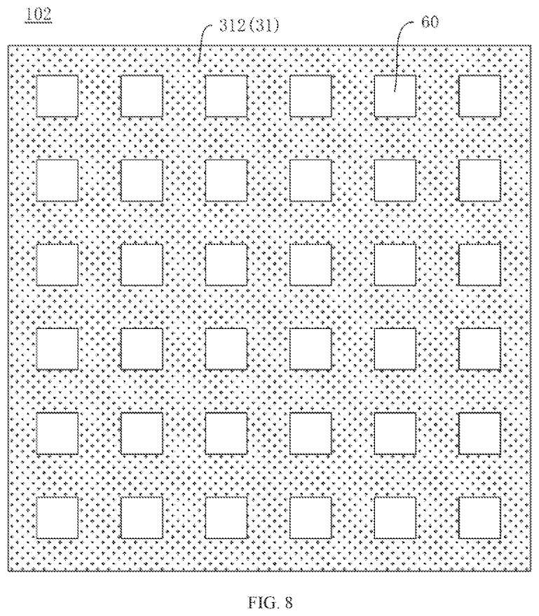

In another example of the present disclosure, referring to FIGS. 7 and 8, this example differs from the above-described examples in that the second conductive layer 30 is disposed on the side of the first conductive layer 20 away from the substrate 10, and the insulating layer 40 is disposed between the first conductive layer 20 and the second conductive layer 30.

The second conductive layer 30 includes a second ground line unit 31 that covers the entire surface of the insulating layer 40 away from the first conductive layer 20. In addition, the second ground line unit 31 is connected with the first ground line unit 21 through the first via 401 and/or the second via 402.

In this example, the light-emitting member 60 is also located on the side of the first conductive layer 20 away from the substrate 10. A plurality of openings are disposed in the second ground line unit 31, and each opening corresponds to one light-emitting member 60, that is, one end of the light-emitting member 60 is electrically connected with the signal traces 22 and the first ground line unit 21 in the first conductive layer 20, and the other end can pass through the openings and protrude from an upper surface of the second ground line unit 31.

Herein, the material of the second ground line unit 31 is a metallic material, and the metallic material is reflective, so that the second ground line unit 31 can also be used as an reflective layer in the backlight module to improve the light-emitting efficiency and brightness of the light-emitting member, and meanwhile, the cost of preparing the reflective layer can be saved. Further, the material of the second ground line unit 31 may be a metal material with high reflectivity.

Based on the above, the second conductive layer 30 disposed in a different layer from the first conductive layer 20 is added, and the second conductive layer 30 includes a second ground line unit 31 connected with the first ground line unit 21 in the first conductive layer 20. Compared with the related arts shown in FIG. 1 and FIG. 2, in which signal traces 3 and ground lines 3 need to be formed in the same metal layer, the ground lines in examples of the present disclosure are divided into a second ground line unit 31 and a first ground line unit 21 disposed in different layers, so that the width of the first ground line unit 21 can be reduced to provide more space for the first conductive layer 20. In this case, the width of the signal traces 22 can be increased according to actual requirements, the resistance of the signal traces 22 can be reduced, the phenomenon of voltage drop and heating generation can be improved, the power consumption of the backlight module can be reduced, and the stability of the backlight module can be improved.

In addition, an example of the present disclosure further provides a display device including the backlight module described in the above-described examples and a display panel, wherein the display panel is disposed at a light-emitting side of the backlight module.

In the above-mentioned examples, the description of each example has its own focus. For parts that are not described in detail in an example, please refer to related descriptions of other examples.

In view of the foregoing, the backlight module and display device provided in examples of the present disclosure have been described in detail above, and the principles and embodiments of the present disclosure are described by using specific examples herein. Descriptions of the above examples are merely intended to help understand the technical solutions and core ideas of the present disclosure. A person with ordinary skill in the art should understand that various modifications may still be made to the technical solutions described in the foregoing examples, or equivalents may be made to some of the technical features therein. These modifications or substitutions do not depart the essence of the corresponding technical solutions from the scope of the technical solutions of the examples of the present disclosure.

What is claimed is:

1. A backlight module comprising:
a substrate;
a first conductive layer disposed on the substrate and comprising a signal trace and a first ground line unit;
a second conductive layer disposed on a side of the first conductive layer close to or away from the substrate and comprising a second ground line unit; and
a light-emitting member electrically connected with the signal trace and the first ground line unit;
wherein the first ground line unit is connected with the second ground line unit.

2. The backlight module according to claim 1, wherein the backlight module comprises a light-emitting area, a peripheral area adjacent to the light-emitting area, and a driving assembly disposed in the peripheral area; the light-emitting member is disposed in the light-emitting area; the first ground line unit comprises a first trace disposed in the peripheral area and a second trace disposed in the light-emitting area, the first trace is connected between the second trace and the driving assembly, and the second trace is connected between the light-emitting member and the first trace; and
wherein the first trace and/or the second trace is connected with the second ground line unit.

3. The backlight module according to claim 2, wherein the backlight module further comprises an insulating layer disposed between the second conductive layer and the first conductive layer, at least one first via located in the peripheral area is disposed in the insulating layer, and the first trace is connected with the second ground line unit through the at least one first via.

4. The backlight module according to claim 3, wherein the second ground line unit comprises a first sub-section disposed in the peripheral area, an orthographic projection of the first trace on the substrate is located within an orthographic projection of the first sub-section on the substrate, and the at least one first via is located between the first sub-section and the first trace.

5. The backlight module according to claim 2, wherein the backlight module further comprises an insulating layer disposed between the second conductive layer and the first conductive layer, at least one second via located in the light-emitting area is disposed in the insulating layer, and the second trace is connected with the second ground line unit through the at least one second via.

6. The backlight module according to claim 5, wherein the second ground line unit comprises a second sub-section disposed in the light-emitting area, an orthographic projection of the second trace on the substrate is located within an orthographic projection of the second sub-section on the substrate, and the at least one second via is located between the second sub-section and the second trace.

7. The backlight module according to claim 2, wherein the second ground line unit corresponds to the light-emitting area and the peripheral area and covers one side of the first conductive layer, and both of an orthographic projection of the first ground line unit on the substrate and an orthographic projection of the signal trace on the substrate are located within an orthographic projection of the second ground line unit on the substrate.

8. The backlight module according to claim 1, wherein the second conductive layer is disposed between the substrate and the first conductive layer, and an orthographic projection of the light-emitting member on the substrate is located within an orthographic projection of the second ground line unit on the substrate.

9. The backlight module according to claim 1, wherein the second conductive layer is provided on the side of the first conductive layer away from the substrate, and an opening corresponding to the light-emitting member is disposed in the second ground line unit.

10. The backlight module according to claim 1, wherein a width of the signal trace is greater than or equal to 30 microns.

11. The backlight module according to claim 1, wherein the backlight module comprises a light-emitting circuit unit disposed in the light-emitting area, and the light-emitting member is connected with the light-emitting circuit unit, and the signal trace comprises a light-emitting signal line and a power line connected with the light-emitting circuit unit.

12. A display device comprising a backlight module and a display panel, wherein the display panel is disposed at a light-emitting side of the backlight module, the backlight module comprises:
a substrate;
a first conductive layer disposed on the substrate and comprising a signal trace and a first ground line unit;
a second conductive layer disposed on a side of the first conductive layer close to or away from the substrate and comprising a second ground line unit; and
a light-emitting member electrically connected with the signal trace and the first ground line unit;
wherein the first ground line unit is connected with the second ground line unit.

13. The display device according to claim 12, wherein the backlight module comprises a light-emitting area, a peripheral area adjacent to the light-emitting area, and a driving assembly disposed in the peripheral area; the light-emitting member is disposed in the light-emitting area; the first ground line unit comprises a first trace disposed in the peripheral area and a second trace disposed in the light-emitting area, the first trace is connected between the second trace and the driving assembly, and the second trace is connected between the light-emitting member and the first trace; and
wherein the first trace and/or the second trace is connected with the second ground line unit.

14. The display device according to claim 13, wherein the backlight module further comprises an insulating layer disposed between the second conductive layer and the first conductive layer, at least one first via located in the peripheral area is disposed in the insulating layer, and the first trace is connected with the second ground line unit through the at least one first via.

15. The display device according to claim 14, wherein the second ground line unit comprises a first sub-section disposed in the peripheral area, an orthographic projection of the first trace on the substrate is located within an orthographic projection of the first sub-section on the substrate, and the at least one first via is located between the first sub-section and the first trace.

16. The display device according to claim 13, wherein the backlight module further comprises an insulating layer disposed between the second conductive layer and the first conductive layer, at least one second via located in the light-emitting area is disposed in the insulating layer, and the second trace is connected with the second ground line unit through the at least one second via.

17. The display device according to claim 16, wherein the second ground line unit comprises a second sub-section disposed in the light-emitting area, an orthographic projection of the second trace on the substrate is located within an orthographic projection of the second sub-section on the substrate, and the at least one second via is located between the second sub-section and the second trace.

18. The display device according to claim 13, wherein the second ground line unit corresponds to the light-emitting area and the peripheral area and covers one side of the first conductive layer, and both of an orthographic projection of the first ground line unit on the substrate and an orthographic projection of the signal trace on the substrate are located within an orthographic projection of the second ground line unit on the substrate.

19. The display device according to claim 12, wherein the second conductive layer is disposed between the substrate and the first conductive layer, and an orthographic projection of the light-emitting member on the substrate is located within an orthographic projection of the second ground line unit on the substrate.

20. The display device according to claim 12, wherein the second conductive layer is provided on the side of the first conductive layer away from the substrate, and an opening corresponding to the light-emitting member is disposed in the second ground line unit.
